(19) United States
(12) Patent Application Publication
(10) Pub. No.: US 2019/0367178 A1
(43) Pub. Date: Dec. 5, 2019

(54) AIRCRAFT SPEED INFORMATION PROVIDING SYSTEM, SPEED INFORMATION PROVIDING METHOD, AND PROGRAM

(71) Applicant: JAPAN AEROSPACE EXPLORATION AGENCY, Chofu-shi, Tokyo (JP)

(72) Inventors: Naoki Matayoshi, Chofu-shi (JP); Tomoko Iijima, Chofu-shi (JP); Jorg Ono Entzinger, Tokyo (JP); Tsuneharu Uemura, Tokyo (JP); Shinji Suzuki, Tokyo (JP)

(73) Assignee: JAPAN AEROSPACE EXPLORATION AGENCY, Chofu-shi, Tokyo (JP)

(21) Appl. No.: 16/332,157

(22) PCT Filed: Apr. 28, 2017
(86) PCT No.: PCT/JP2017/016992

§ 371 Date: Mar. 11, 2019

(30) Foreign Application Priority Data
Sep. 14, 2016 (JP) 2016-179268

(51) Int. Cl. B64D 43/02; G01P 5/00

(52) U.S. Cl. CPC B64D 43/02; G01S 17/95; G01P 5/00

(57) ABSTRACT

To realize stable airspeed control considering remote turbulence, the present invention provides an aircraft speed information providing system includes: an airspeed measurement device that measures a present airspeed of an aircraft; an acceleration measurement device that measures present acceleration of the aircraft; a remote turbulence measurement device that measures remote turbulence in front of the aircraft; and a computation processing device that calculates a predicted airspeed of the aircraft on the basis of the measured present airspeed and present acceleration and the remote turbulence measured by the remote turbulence measurement device.

### TECHNICAL FIELD

The present invention relates to an aircraft speed information providing system, a speed information providing method, and a program for providing speed information on an predicted airspeed, a target airspeed, and the like considering influence of remote turbulence in front of an aircraft.

### BACKGROUND ART

An aircraft speed indication generally includes a target airspeed indication called “selected speed” or “speed bug”, a predicted airspeed indication called “speed trend vector”, and the like. In general, the target airspeed is speed information provided complying with aircraft performance limits, objectives, instructions from the control, regulations of airline companies, and regulations during flight.

Further, the predicted airspeed is information on a predicted speed to be given several seconds later (e.g., ten seconds later), which is calculated on the basis of information on increase/decrease in aircraft speed (see Non-Patent Literature 1). For maintaining a constant speed, a pilot conducts a thrust operation for reducing the speed if the predicted airspeed tends to increase ten seconds later or for increasing the speed if the predicted airspeed tends to decrease ten seconds later. Further, the pilot conducts a manual thrust operation such that the aircraft has a target airspeed. Alternatively, not relying on pilot's manual operations, an automatic thrust control device (e.g., auto throttle or the like) can also automatically control thrust so as to obtain a target airspeed.

### CITATION LIST

### Patent Literature

Patent Literature 1: Japanese Patent Application Laid-open No. 2010-217077

Patent Literature 2: Japanese Patent Application Laid-open No. 2015-056055

### Non-Patent Literature

Non-Patent Literature 1: Instrument Flying Handbook (FAA-H-8083-15A, 6-26)

Non-Patent Literature 2: “Operational Evaluation of Low Level Turbulence Advisory System” (51st Aircraft Symposium, JSASS-2013-5174, November 2013, Kagawa) by Tomoko Iijima, Naoki Matayoshi, and Eiichi Yoshikawa

Non-Patent Literature 3: “Development and Evaluation of Airport Low level Wind Information” (53rd Aircraft Symposium, 2G03, November 2015, Matsuyama) by Tomoko Iijima, Naoki Matayoshi, Eiji Fujita, and Kentaro Yamamoto

### DISCLOSURE OF INVENTION

### Technical Problem

However, in general, influence of turbulence (remote turbulence) in front of an aircraft is not considered in calculating a predicted airspeed and a target airspeed given to the aircraft, and thus the predicted airspeed and the target airspeed given to the aircraft have errors at least corresponding thereto. For that reason, if the airspeed of the aircraft suddenly changes due to the influence of the turbulence when the pilot tries to enter a runway at a target airspeed determined by the pilot for landing, for example, the pilot may have to conduct a go-around. More specifically, there is a case where the headwind changes into the tailwind while losing the altitude and the airspeed is lowered to approach the stall speed. In such a case, a go-around is conducted.

Also in thrust control based on the target airspeed by the automatic thrust control device, there is a possibility that an error corresponding to influence due to a turbulence change may be included.

A remote turbulence measurement device such as a Doppler lidar and a Doppler radar is known as means for measuring turbulence. For example, there is known a method of measuring turbulence by the Doppler lidar in order to provide the pilot with an alarm indication regarding a situation where wind suddenly changes like severe wind shear (see Patent Literature 1). However, in a manner that depends on a situation where turbulence fluctuates, there are not a few cases where it becomes difficult to control the airspeed of the aircraft so as to correspond to the turbulence fluctuation even without alarm and a go-around is conducted.

Further, there is known a technology of notifying an aircraft of remote turbulence information via a data link from a sensor (e.g., Doppler radar for airport weather, Doppler lidar for airport weather, etc.) that is placed on the ground and measures remote turbulence (e.g., Patent Literature 2). However, regarding that system, it has been reported that there is a delay of about ten minutes from turbulence measurement to information provision (Non-Patent Literature 2) and it has also been reported that an actual turbulence state is different from information (Non-Patent Literature 3).

In view of the above-mentioned circumstances, it is an object of the present invention to provide an aircraft speed information providing system, a speed information providing method, and a program, by which stable airspeed control considering remote turbulence can be realized.

### Solution to Problem

In order to solve the above-mentioned problem, an aircraft speed information providing system according to an embodiment of the present invention includes: an airspeed measurement device that measures a present airspeed of an aircraft; an acceleration measurement device that measures present acceleration of the aircraft; a remote turbulence measurement device that is installed in the aircraft and measures remote turbulence in front of the aircraft; and a computation processing device that calculates a predicted airspeed of the aircraft on the basis of the measured present airspeed and present acceleration and the remote turbulence measured by the remote turbulence measurement device.

In the present invention, the predicted airspeed considering the remote turbulence in front of the aircraft can be calculated. By providing the pilot with this predicted airspeed, the pilot can select a manual throttle operation for optimal thrust control for maintaining a target speed while considering the predicted airspeed considering the remote turbulence in front of the aircraft.

The computation processing device may be configured to further calculate a variation amount of the predicted airspeed.

By providing the pilot with the information on the predicted airspeed including the variation amount, the pilot can select a manual throttle operation for more optimal thrust control for maintaining a target speed while considering the predicted airspeed including the variation amount.

The computation processing device may be configured to calculate the predicted airspeed and the variation amount at each of a plurality of times.

By providing the pilot with information on the predicted airspeed and the variation amount at each of the plurality of times, the pilot can select a manual throttle operation for more optimal thrust control for maintaining a target reference speed while considering a change in predicted airspeed and the variation amount between the plurality of times.

Further, the computation processing device may be configured to cause a cockpit instrument to display the calculated predicted airspeed and variation amount.

The computation processing device may be configured to generate a warning notification when the predicted airspeed considering the calculated variation amount is within a warning region.

The speed management burden on the pilot can be lightened and the safety can be enhanced.

The computation processing device may be configured to calculate a target airspeed on the basis of a difference between the calculated predicted airspeed and present airspeed, the calculated variation amount, and a reference speed such as a reference speed by pilot setting.

By providing the pilot with the target airspeed, for example, the pilot can select a more optimal manual throttle operation for maintaining the reference speed by the pilot setting while considering the target airspeed considering the remote turbulence.

The computation processing device may be configured to calculate the target airspeed while considering a configuration of the aircraft.

In addition, the computation processing device may be configured to cause the cockpit instrument to display the calculated target airspeed.

Further, the computation processing device may be configured to calculate control data for automatic thrust control on the basis of the calculated target airspeed.

By outputting this control data to the automatic thrust control device, more stable automatic thrust control considering the remote turbulence in front of the aircraft is realized.

An aircraft speed information providing method according to another embodiment of the present invention includes: by a computation processing device installed in an aircraft, inputting data on remote turbulence in front of an aircraft measured by a remote turbulence measurement device installed in the aircraft; and calculating a predicted airspeed of the aircraft on the basis of the data on the remote turbulence and respective data on a present airspeed and acceleration of the aircraft.

A program according to another embodiment of the present invention causes a computer to operate as a computation processing device that inputs data on remote turbulence in front of an aircraft measured by a remote turbulence measurement device installed in the aircraft, and calculates a predicted airspeed of the aircraft on the basis of the data on the remote turbulence and respective data on a present airspeed and acceleration of the aircraft.

### Advantageous Effects of Invention

As described above, in accordance with the present invention, it is possible to provide an aircraft speed information providing system, a speed information providing method, and a program, by which stable airspeed control considering remote turbulence can be realized.

### BRIEF DESCRIPTION OF DRAWINGS

FIG. 1 A block diagram showing an entire configuration of an aircraft speed information providing system 1 according to an embodiment of the present invention.

FIG. 2 A diagram showing a flow of entire computation processing by a computation processing device 4 in the speed information providing system 1 of FIG. 1.

FIG. 3 A diagram showing a flow of L-PSPD raw data calculation processing (S10) of FIG. 2.

FIG. 4 A diagram for describing a calculation method for a predicted airspeed in the L-PSPD raw data calculation processing (S10) of FIG. 2.

FIG. 5 A diagram for describing a calculation method for a variation amount of a predicted airspeed in the L-PSPD raw data calculation processing (S10) of FIG. 2.

FIG. 6 A diagram showing a flow of L-TSPD raw data calculation processing (S20) of FIG. 2.

FIG. 7 A diagram showing a flow of processing regarding display and warning from the L-PSPD raw data in L-PSPD & L-TSPD provision data calculation processing in FIG. 2.

FIG. 8 A diagram showing a flow of display processing and warning processing for L-TSPD information based on L-TSPD raw data in the L-PSPD & L-TSPD provision data calculation processing of FIG. 2.

FIG. 9 A diagram showing an example of primary flight display including a display symbol of L-PSPD information and L-TSPD information.

FIG. 10 An enlarged diagram of a predicted airspeed indicator 11 and a predicted speed symbol group 13 in the primary flight display of FIG. 9.

FIG. 11 A block diagram showing an entire configuration of a typical aircraft predicted airspeed information providing system (e.g., speed trend vector).

### MODE(S) FOR CARRYING OUT THE INVENTION

Hereinafter, an embodiment of the present invention will be described.

An aircraft speed information providing system of this embodiment is a system capable of providing the pilot and the automatic thrust control device with speed information on a predicted airspeed to be given several seconds to several tens of seconds later, a target airspeed, and the like, for example, considering remote turbulence in front of an aircraft.

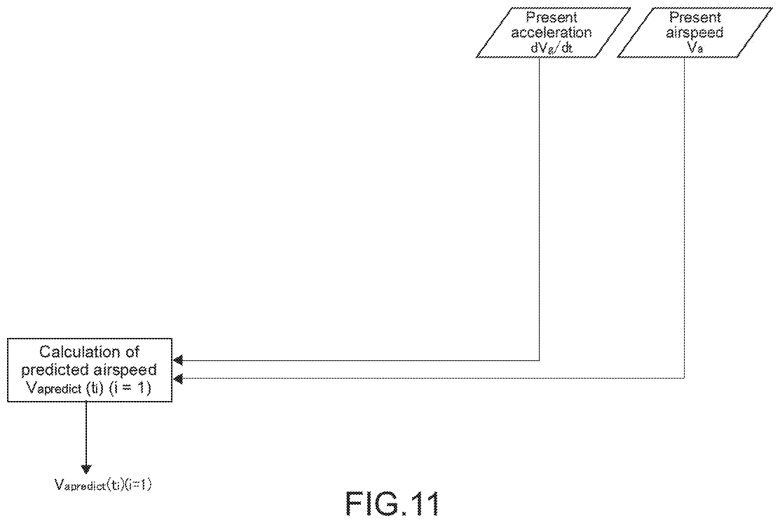

FIG. 11 is a block diagram showing a typical method of generating the speed information on the predicted airspeed given several seconds to several tens of seconds later and the like. In this typical method, on the basis of a present airspeed Vₐ and present dV_{g}/dₜ, the computation processing device calculates, for example, a predicted airspeed V_{apredict} (tᵢ) (i=1) at a time (t₁) determined in a range of several seconds to several tens of seconds. In accordance with this method, a calculation result includes an error at least corresponding to influence of the remote turbulence in front of the aircraft, which is not considered. The aircraft speed information providing system of this embodiment can at least overcome such an error, which is one of effects.

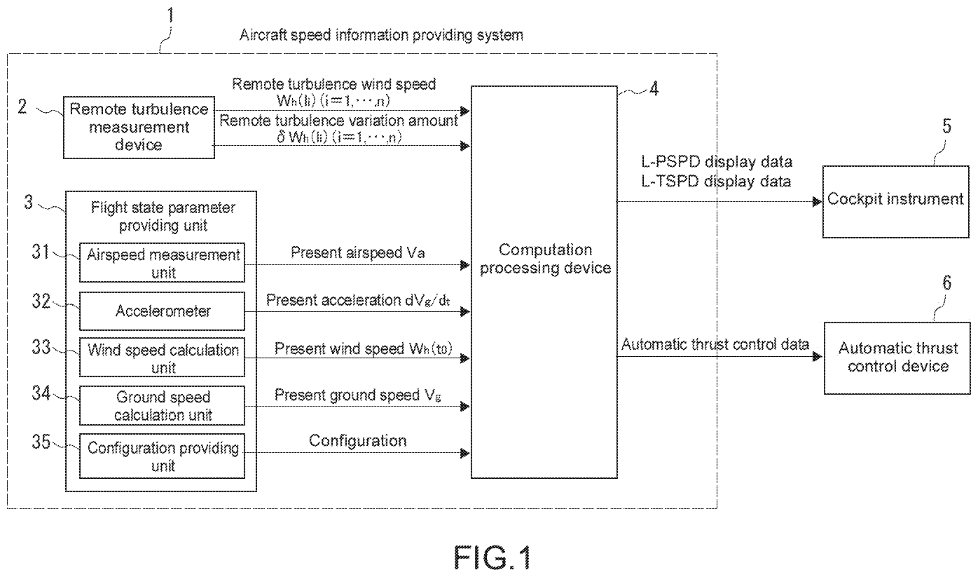

FIG. 1 is a block diagram showing an entire configuration of the aircraft speed information providing system 1 of this embodiment.

As shown in the figure, this aircraft speed information providing system 1 includes a remote turbulence measurement device 2, a flight state parameter providing unit 3, and a computation processing device 4.

The remote turbulence measurement device 2 is a device that measures a wind speed and a direction of a direction component along the aircraft axis in the remote turbulence in front of the aircraft. More specifically, the remote turbulence measurement device 2 is a Doppler lidar or the like. The Doppler lidar is capable of emitting (transmitting) laser light as a transmission signal into the atmosphere, receiving scattered laser light of the laser light due to aerosol in the atmosphere as a reception signal, and measuring turbulence in a remote region at approximately several km to several tens of km in front, for example, on the basis of a Doppler shift amount between the transmission signal and the reception signal.

It should be noted that in the present invention, the remote turbulence measurement device 2 is not limited to the Doppler lidar and may be another type of turbulence sensor. Further, it is not limited to the type installed in the aircraft and may acquire turbulence data through a data link from a turbulence sensor placed on the ground or a turbulence sensor installed in another aircraft.

The remote turbulence measurement device 2 generates data on a wind speed mean value in an aircraft axis direction and the like for each different distance (lᵢ) (i=1, . . . , n) as wind speed data Wₕ (lᵢ) (i=1, . . . , n) of the remote turbulence at each distance on the basis of the measured turbulence data. The remote turbulence measurement device 2 outputs it to the computation processing device 4 in real time. For example, provided that an entire measurement distance is 6 km, the distance of 6 km is divided into a range of a distance (1₁) of 0 to 2 km, a range of a distance (l₂) of 2 km to 4 km, and a range of a distance (l₃) of 4 km to 6 km. A wind speed mean value and the like, for example, in each distance range are generated as wind speed data Wₕ (lᵢ) (i=1, 2, 3) of the remote turbulence at each distance (lᵢ) (i=1, 2, 3). Those are output to the computation processing device 4 in real time. Here, each distance range does not necessarily need to be the same.

Further, the remote turbulence measurement device 2 generates wind speed variation amount data δWₕ (lᵢ) (i=1, . . . , n) of the remote turbulence at each distance (lᵢ) (i=1, . . . , n) and outputs it to the computation processing device 4 in real time. The wind speed variation amount data δWₕ (lᵢ) (i=1, . . . , n) indicates, for example, a standard deviation of a variation amount of the wind speed of the remote turbulence in the aircraft axis direction, which is measured within a target distance range.

The flight state parameter providing unit 3 includes various measurement devices, calculation devices, and the like that measure various parameters (flight state parameters) indicating a state of the aircraft during flight and output them to the computation processing device 4. The flight state parameter providing unit 3 includes an airspeed measurement unit 31, an accelerometer 32, a wind speed calculation unit 33, a ground speed calculation unit 34, a configuration providing unit 35, and the like. The airspeed measurement unit 31 is a device that measures a present airspeed Vₐ of the aircraft. The accelerometer 32 is a device that measures present acceleration dV_{g}/dₜ of the aircraft. The wind speed calculation unit 33 is a device that measures a present wind speed Wₕ (l₀) in the aircraft axis direction, which is experienced by the aircraft. The ground speed calculation unit 34 is a device that calculates a present ground speed V_{g} of the aircraft by using global positioning system (GPS) information and the like, for example. The configuration providing unit 35 is a device that provides information on a configuration such as present gear state, flap state, weight, and the like of the aircraft.

The computation processing device 4 includes a control unit, a storage unit, an input unit, an output unit, a transmission and reception unit, and the like. The control unit includes a central processing unit (CPU) and the like. By operating in accordance with software developed in the storage unit, the control unit executes various types of computation processing such as processing of calculating a predicted airspeed and processing of calculating a target airspeed. The storage unit includes a read only memory (ROM) and a random access memory (RAM). The transmission and reception unit transmits and receives data to/from the respective devices 31 to 35 inside the remote turbulence measurement device 2 and the flight state parameter providing unit 3.

The computation processing device 4 is configured to perform computation processing as follows on the basis of the wind speed data Wₕ (lᵢ) (i=1, . . . , n) of the remote turbulence at each distance and the wind speed variation amount data δWₕ (lᵢ) (i=1, . . . , n) at each distance, which are input by the remote turbulence measurement device 2, and the flight state parameters provided by the respective devices 31 to 35 inside the flight state parameter providing unit 3.

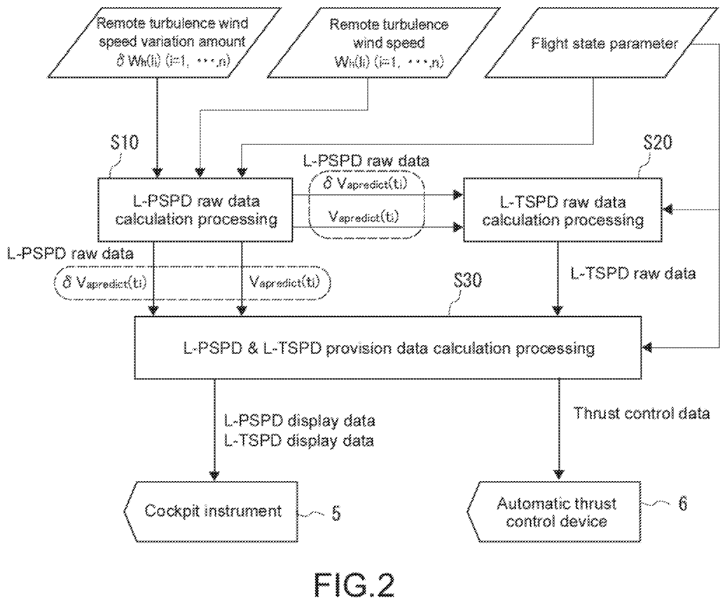

FIG. 2 is a diagram showing a flow of entire computation processing by the computation processing device 4.

Main computation processing performed in the computation processing device 4 includes L-PSPD raw data calculation processing (S10), L-TSPD raw data calculation processing (S20), and L-PSPD & L-TSPD provision data calculation processing (S30).

L-PSPD Raw Data Calculation Processing (S10)

On the basis of the wind speed data Wₕ (lᵢ) (i=1, . . . , n) of the remote turbulence at each distance and the wind speed variation amount data δWₕ (lᵢ) (i=1, . . . , n) at each distance, which are input by the remote turbulence measurement device 2, and the flight state parameters provided by the flight state parameter providing unit 3, the computation processing device 4 calculates a predicted airspeed V_{apredict} (tᵢ) (i=1, . . . , n) at each time (tᵢ) (i=1, . . . , n) corresponding to each distance (lᵢ) (i=1, . . . , n) and a variation amount thereof δV_{apredict} (tᵢ) (i=1, . . . , n). Here, information on the calculated predicted airspeed and variation amount thereof is called “L-PSPD raw data”. The L-PSPD is an abbreviation of a lidar-predictive speed.

L-TSPD Raw Data Calculation Processing (S20)

The computation processing device 4 calculates a target airspeed on the basis of the L-PSPD raw data calculated in the above-mentioned L-PSPD raw data calculation processing (S10) and the flight state parameters provided by the flight state parameter providing unit 3. Here, the calculated target airspeed is called “L-TSPD raw data”. The L-TSPD is an abbreviation of a lidar-target speed.

L-PSPD & L-TSPD Providing Data Calculation Processing (S30)

The computation processing device 4 performs processing of displaying, on a cockpit instrument 5, the L-PSPD raw data calculated in the above-mentioned L-PSPD raw data calculation processing (S10) and the L-TSPD raw data calculated in the above-mentioned L-TSPD raw data calculation processing (S20), processing of notifying a pilot of a warning via the cockpit instrument 5 when the L-PSPD raw data is within the warning region, processing of calculating thrust control data to be output to an automatic thrust control device 6 by using the L-TSPD raw data, and the like.

Next, each type of the above-mentioned processing (S10), (S20), and (S30) will be described in detail.

(Details of L-PSPD Raw Data Calculation Processing)

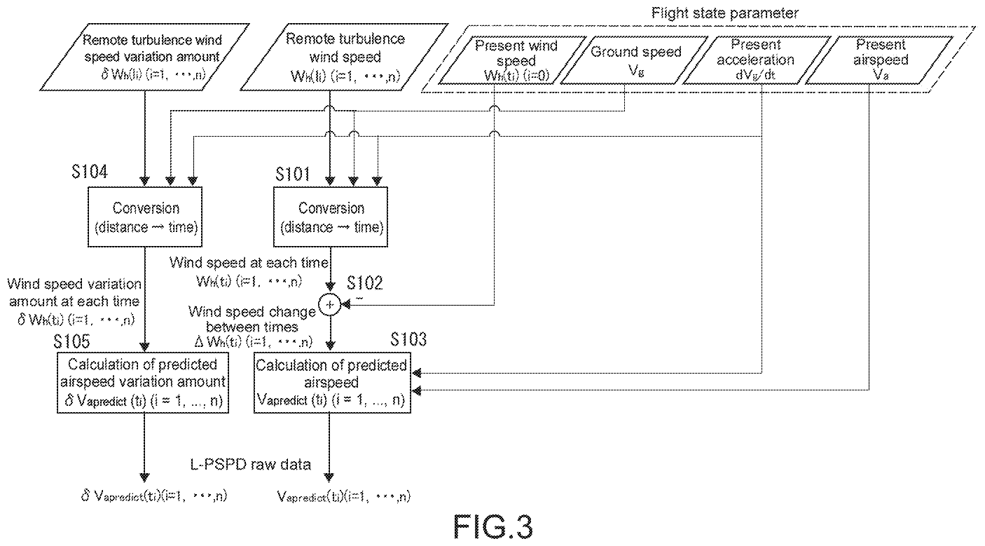

FIG. 3 is a diagram showing a flow of the L-PSPD raw data calculation processing (S10).

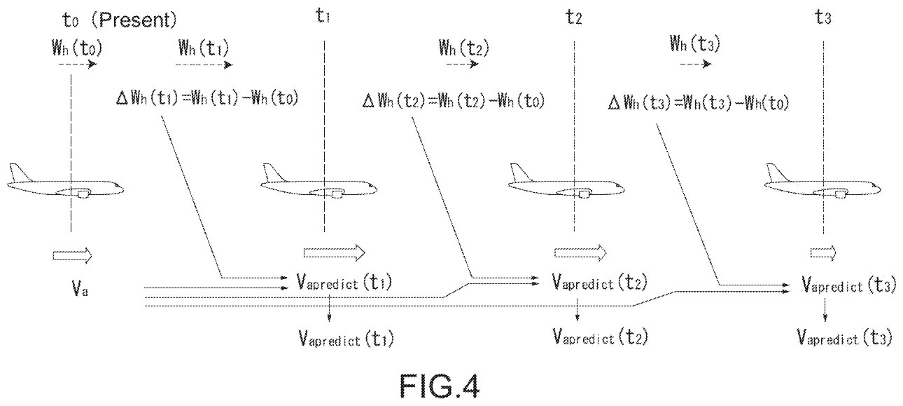

FIG. 4 is a diagram for describing a calculation method for a predicted airspeed in the L-PSPD raw data calculation processing (S10).

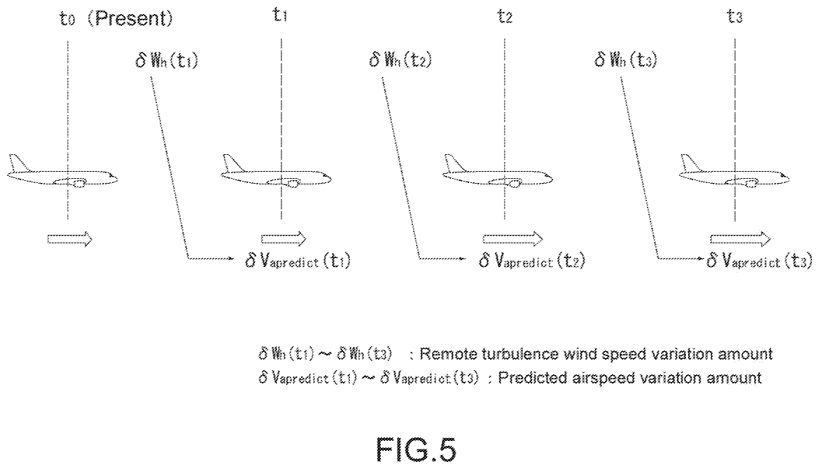

FIG. 5 is a diagram for describing a calculation method for a variation amount of a predicted airspeed in the L-PSPD raw data calculation processing (S10).

(Calculation of Predicted Airspeed)

As shown in FIG. 3, the computation processing device 4 inputs the wind speed data Wₕ (lᵢ) (i=1, . . . , n) of the remote turbulence in each distance range from the remote turbulence measurement device 2. Next, the computation processing device 4 converts the input wind speed data Wₕ (lᵢ) (i=1, . . . , n) of the remote turbulence in each distance range into wind speed data Wₕ (tᵢ) (i=1, . . . , n) at each time (S101 in FIG. 3). In order to perform this distance-to-time conversion, the computation processing device 4 inputs present ground speed data V_{g} and present acceleration data dV_{g}/dₜ through the flight state parameter providing unit 3 and calculates a time (tᵢ) (i=1, . . . , n) when the aircraft reaches a point at each distance (lᵢ) (i=1, . . . , n) described above on the basis of that data.

As shown in FIG. 4, a case of calculating a predicted airspeed V_{apredict} (tᵢ) (i=1, 2, 3) at each of three times will be considered.

On the basis of the converted wind speed data Wₕ (tᵢ) (i=1, 2, 3) at each time and present wind speed data Wₕ (t₀) input from the flight state parameter providing unit 3, the computation processing device 4 determines a wind speed change ΔWₕ (tᵢ) (i=1, 2, 3) between the times (S102 in FIG. 3). Here, it is assumed that a wind speed change from a present time (t₀) to the time (tᵢ) is ΔWₕ (t₁), a wind speed change from the time (t₁) to the time (t₂) is ΔWₕ (t₂), and a wind speed change from the time (t₂) to the time (t₃) is ΔWₕ (t₃).

Next, on the basis of present airspeed data Vₐ input by the flight state parameter providing unit 3 and the present acceleration data dV_{g}/dₜ and a wind speed change ΔWₕ (t₁), the computation processing device 4 calculates a predicted airspeed V_{apredict} (t₁) at the time (t₁) (S103 in FIG. 3). For example, in a case where the present wind speed data Wₕ (t₀) is 5 kt in a tailwind direction and a wind speed data Wₕ (t₁) of the remote turbulence at the time (t₁) is 8 kt in the tailwind direction, the wind speed change ΔWₕ (t₁) between the present time (t₀) to the time (t₁) is an “increase by 3 kt in the tailwind direction”. In this case, for example, a result of addition or subtraction of the wind speed change ΔWₕ (t₁) to/from the predicted airspeed at the time (t₁), which is calculated on the basis of the present airspeed Vₐ, the present acceleration dV_{g}/dₜ, and the like without considering the remote turbulence may be the predicted airspeed V_{apredict} (t₁) at the time (t₁).

Also regarding the time (t₂), the computation processing device 4 uses a result of addition or subtraction of the wind speed change ΔWₕ (t₂) to/from the predicted airspeed at the time (t₂), which is calculated on the basis of the present airspeed Vₐ, the present acceleration dV_{g}/dₜ, and the like without considering the remote turbulence, as a predicted airspeed V_{apredict} (t₂) at the time (t₂). In this manner, the predicted airspeed V_{apredict} (tᵢ) (i=1, . . . , n) at each time, which considers influence of the remote turbulence, is calculated.

(Calculation of Variation Amount of Predicted Airspeed)

The computation processing device 4 inputs the wind speed variation amount data δWₕ (lᵢ) (i=1, . . . , n) of the remote turbulence at each distance through the remote turbulence measurement device 2. The computation processing device 4 converts data on the input wind speed variation amount δWₕ (lᵢ) (i=1, . . . , n) of the remote turbulence at each distance into data on wind speed variation amount data δWₕ (tᵢ) (i=1, . . . , n) at each time (tᵢ) (i=1, . . . , n) (Step S104 of FIG. 3). In order to perform this distance-to-time conversion, the computation processing device 4 inputs the present ground speed data V_{g} of the aircraft and the present acceleration data dV_{g}/dₜ of the aircraft through the flight state parameter providing unit 3 and calculates a time (tᵢ) (i=1, . . . , n) when the aircraft reaches a point at each distance (lᵢ) (i=1, . . . , n) described above on the basis of that data.

The computation processing device 4 obtains the converted wind speed variation amount data δWₕ (tᵢ) (i=1, . . . , n) of the remote turbulence at each time as predicted airspeed variation amount data δV_{apredict} (tᵢ) (i=1, . . . , n) at each time (Step S105 of FIG. 3). For example, as shown in FIG. 5, for calculating the predicted airspeed V_{apredict} (tᵢ) (i=1, 2, 3) at each of three times, the computation processing device 4 sets wind speed variation amount data δWₕ (t₁) of the remote turbulence of the time (t₀) to the time (t₁) as predicted airspeed variation amount data δV_{apredict} (t₁) at the time (t₁), sets wind speed variation amount data δWₕ (t₂) of the remote turbulence from the time (t₁) to the time (t₂) as predicted airspeed variation amount data δV_{apredict} (t₂) at the time (t₂), and sets wind speed variation amount data δWₕ (t₃) of the remote turbulence from the time (t₂) to the time (t₃) as predicted airspeed variation amount data δV_{apredict} (t₃) at the time (t₃).

(Details of L-TSPD Raw Data Calculation Processing)

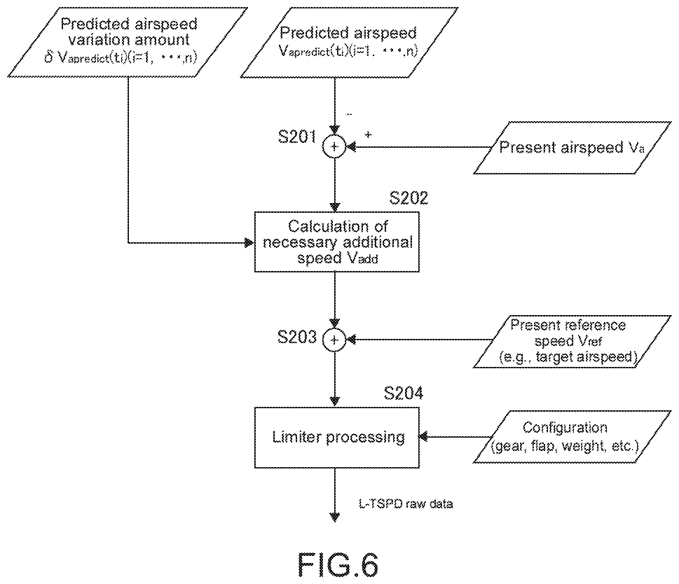

FIG. 6 is a diagram showing a flow of the L-TSPD raw data calculation processing (S20) of FIG. 3.

The computation processing device 4 compares the predicted airspeed V_{apredict} (tᵢ) (i=1, . . . , n) at each time in the L-PSPD raw data calculated in the L-PSPD raw data calculation processing (S10) with the present airspeed Vₐ provided from the flight state parameter providing unit 3 (S201 in FIG. 6). Next, the computation processing device 4 calculates necessary additional speed V_{add} on the basis of the respective comparison results and the variation amount of the predicted airspeed δV_{apredict} (tᵢ) (i=1, . . . , n) at the corresponding time calculated in the L-PSPD raw data calculation processing (S10) (S202 in FIG. 6). More specifically, if the predicted airspeed V_{apredict} (tᵢ) (i=1, . . . , n) is lower than the present airspeed Vₐ, a value obtained by adding the variation amount of the predicted airspeed δV_{apredict} (tᵢ) (i=1, . . . , n) to a speed difference between the present airspeed Vₐ and the predicted airspeed V_{apredict} (tᵢ) (i=1, . . . , n) is set as the necessary additional speed V_{add} which is positive.

It should be noted that information to be used for calculation of the additional speed V_{add} may be the predicted airspeeds V_{apredict} (tᵢ) (i=1, . . . , n) and the amounts of fluctuation δV_{apredict} (tᵢ) (i=1, . . . , n) at all the times or may be the predicted airspeed V_{apredict} (tᵢ) and the variation amount δV_{apredict} (tᵢ) at any one or more times.

Next, the computation processing device 4 subjects the determined additional speed V_{add} to limiter processing with upper and lower limit values determined in accordance with a present configuration of the aircraft (e.g., gear, flap, aircraft weight, etc.) (not shown).

Next, the computation processing device 4 adds the additional speed V_{add} subjected to the limiter processing to a reference speed V_{ref} according to pilot setting and the like of a present target airspeed, for example (S203 in FIG. 6).

The computation processing device 4 subjects the above-mentioned result of addition to the limiter processing with the upper and lower limit values determined in accordance with the present configuration of the aircraft (e.g., gear, flap, aircraft weight, etc.) and sets the result thereof as the target airspeed (L-TSPD raw data).

(Details of L-PSPD & L-TSPD Providing Data Calculation Processing)

Next, the L-PSPD & L-TSPD provision data calculation processing of calculating data available by the cockpit instrument 5 and the automatic thrust control device 6 on the basis of the L-PSPD raw data and L-TSPD raw data calculated in the above-mentioned manner will be described in detail.

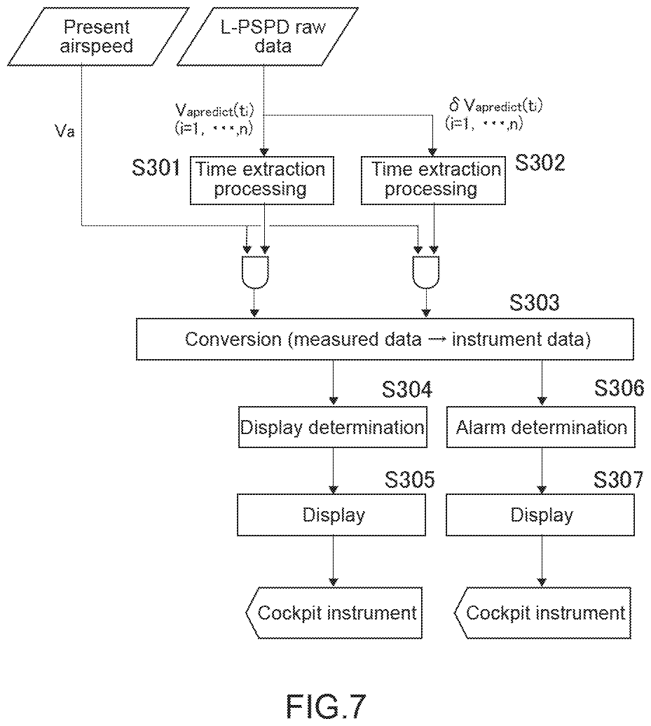

FIG. 7 is a diagram showing a flow of processing regarding display and warning of the L-PSPD raw data.

The computation processing device 4 extracts each piece of data at a common time on the basis of the predicted airspeed V_{apredict} (tᵢ) and the variation amount δV_{apredict} (tᵢ) at each time (tᵢ) (i=1, . . . , n), which are the L-PSPD raw data (S301 and S302 in FIG. 7). The computation processing device 4 converts the extracted data into data in a format that can be handled by the cockpit instrument 5 (S303 in FIG. 7).

Next, the computation processing device 4 determines whether a predetermined condition for the converted data to be displayed by the cockpit instrument 5 is satisfied (S304 in FIG. 7). The computation processing device 4 causes a primary flight display which is a main device of the cockpit instrument 5 to display the L-PSPD information if that displaying condition (S305 in FIG. 7).

It should be noted that the fact that a mean value of a difference between the predicted airspeed V_{apredict} (tᵢ) (i=1, . . . , n) at each time and the present airspeed Vₐ is equal to or higher than a threshold or the like can be exemplified as the condition for displaying the L-PSPD information, though the L-PSPD information may be constantly displayed with no conditions without setting the threshold.

Further, regarding warning processing of the predicted airspeed, if the computation processing device 4 determines that the predicted airspeed V_{apredict} (tᵢ) considering the variation amount δV_{apredict} (tᵢ), for example, either one of a minimum predicted airspeed V_{apredict} (tᵢ) or a maximum predicted airspeed V_{apredict} (tᵢ) considering the variation amount δV_{apredict} (tᵢ) is within the warning region (S306 in FIG. 7), control is performed to perform a warning notification to the pilot via the cockpit instrument 5 (S307 in FIG. 7). The warning notification may be visually performed via a display of the cockpit instrument 5 and may also be performed with sounds. For example, the computation processing device 4 performs control to perform the warning notification if the minimum predicted airspeed V_{apredict} (tᵢ) considering the variation amount δV_{apredict} (tᵢ) is lowered and enters the warning region determined in accordance with the configuration of the aircraft (gear, flap, weight, etc.)

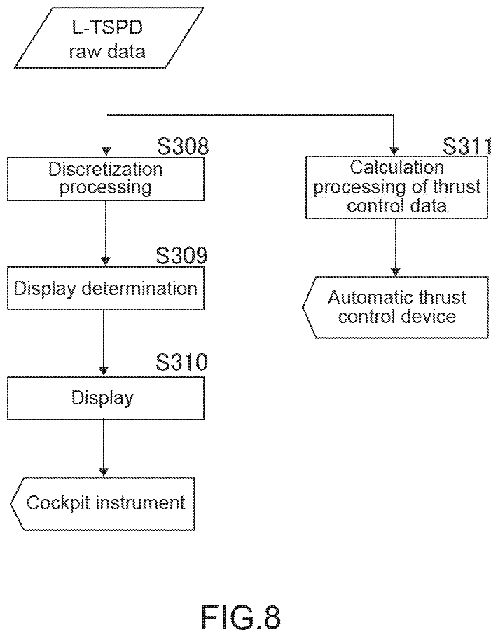

FIG. 8 is a diagram showing a flow of display processing and warning processing of the L-TSPD information, which are based on the L-TSPD raw data.

First of all, the computation processing device 4 performs discretization processing on the L-TSPD raw data (S308). This processing is performed as follows, for example.

L-TSPD=round (L-TSPD/ΔTSPD)*ΔTSPD

Here, round is conversion processing into an integer value by rounding off.

ΔTSPD is a resolution for discretization.

Next, the computation processing device 4 determines whether the predetermined condition for the discretized L-TSPD to be displayed by the cockpit instrument 5 is satisfied (S309). This determination is performed on the basis of whether Condition 1 below or two conditions of Conditions 1 and 2 are satisfied, for example.

Condition 1: the fact that an absolute value of a difference between the L-TSPD and a target speed of the pilot setting is equal to or larger than a threshold.

Condition 2: the fact that regarding the predicted airspeed V_{apredict} (tᵢ) and variation amount δV_{apredict} (tᵢ) used for calculation of the additional speed V_{add}, either one of the predicted airspeed V_{apredict} (tᵢ)+2* the variation amount δV_{apredict} (tᵢ) or the predicted airspeed V_{apredict} (tᵢ)−2* the variation amount δV_{apredict} (tᵢ) is larger than the set upper limit value or is lower than the set lower limit value.

If determining that the above-mentioned two conditions are satisfied, the computation processing device 4 causes the primary flight display which is the main device of the cockpit instrument 5 to display the L-TSPD information (S310).

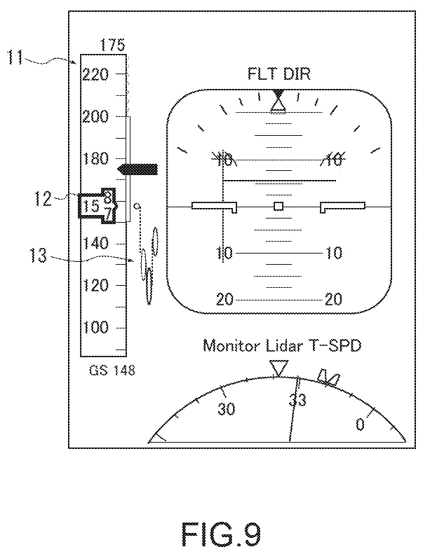

FIG. 9 is a diagram showing an example of the primary flight display including the display symbol of the L-PSPD information and the L-TSPD information.

An airspeed indicator 11, in which higher speeds are assigned to upper height positions and which is also called speed tape, is arranged in the primary flight display. An indicator 12 of the present airspeed Vₐ is arranged at a middle height position of the airspeed indicator 11. In the example shown in the figure, the present airspeed Vₐ is between 157 kt to 158 kt. The predicted speed symbol group 13 indicating the predicted airspeed (tᵢ) (i=1, . . . , n) and the variation amount thereof δV_{apredict} (tᵢ) (i=1, . . . , n) at each time is arranged near the airspeed indicator 11.

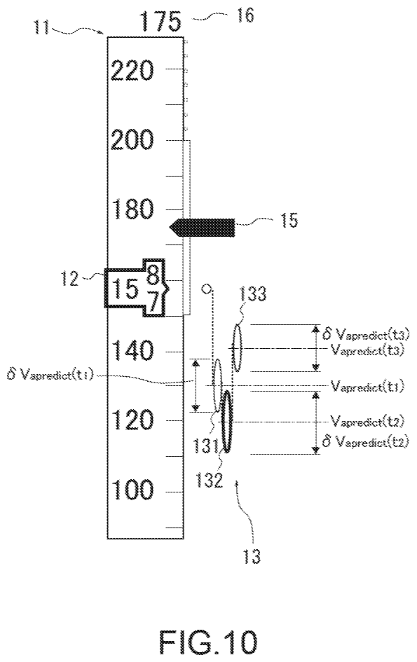

FIG. 10 is an enlarged diagram of the airspeed indicator 11 and the predicted speed symbol group 13 in the primary flight display.

Here, the predicted speed symbol group 13 includes predicted speed symbols 131, 132, and 133 at respective times (tᵢ) (i=1, 2, 3). That is, the predicted speed symbol 131 indicates the predicted airspeed V_{apredict} (t₁) and the variation amount δV_{apredict} (t₁) at the time (t₁), the predicted speed symbol 132 indicates the predicted airspeed V_{apredict} (t₂) and the variation amount δV_{apredict} (t₂) at the time (t₂), and the predicted speed symbol 133 indicates the predicted airspeed V_{apredict} (t₃) and the variation amount δV_{apredict} (t₃) at the time (t₃).

A length in a speed axis direction of the airspeed indicator 11 of the respective predicted speed symbols 131, 132, and 133 indicates the variation amount δV_{apredict} (tᵢ) and the position on the speed axis of the airspeed indicator 11 at a middle height of the predicted speed symbols 131, 132, and 133 indicates the predicted airspeed V_{apredict} (tᵢ). The predicted speed symbols 131, 132, and 133 has a shape easy to check the middle height at a glance, for example, a vertically-long elliptical shape or the like. The horizontal positions of those three predicted speed symbols 131, 132, and 133 correspond to the times. A horizontal position closer to the airspeed indicator 11 indicates that it is closer to the present time.

The respective predicted speed symbols 131, 132, and 133 may be displayed with a display format, for example, line color, line type, thickness, texture, and the like changed. For example, predetermined color, line type, thickness, and texture may be assigned for each of the predicted speed symbols in an order from the predicted speed symbol at the time closer to the present time.

Further, if the speed enters a region corresponding to a stall speed, a never-exceed speed, or the like, it may be displayed with the color changed for warning or attracting attention.

Further, a target speed symbol 15 indicating the target airspeed and a speed value 16 thereof are displayed on the airspeed indicator 11. The example of the figure indicates that the target airspeed is 175 kt.

(Application to Automatic Thrust Control)

In addition, as shown in FIG. 8, the computation processing device 4 calculates thrust control data on the basis of the target airspeed (L-TSPD raw data) on an automatic operation mode and provides it to the automatic thrust control device 6 (S311). With this, automatic thrust control considering the remote turbulence is realized.

As described above, in the speed information providing system 1 of this embodiment, the remote turbulence in front of the aircraft information measured by the remote turbulence measurement device 2 mounted on the aircraft is given to the computation processing device 4 in real time. The computation processing device 4 calculates the predicted airspeed to be given several seconds to several tens of seconds later and the target airspeed by using the remote turbulence information thereof and provides it to the pilot via the cockpit instrument 5. While considering the predicted airspeed to be given several seconds to several tens of seconds later and the target airspeed, the pilot can select a manual throttle operation of optimal thrust control for maintaining a target speed. For example, the pilot can know that there is a possibility that the airspeed of the aircraft may be lowered due to a sudden change of the turbulence, in particular, a change from the headwind to the tailwind during landing approach, several seconds to several tens of seconds before it happens. Therefore, it becomes possible to reduce the number of times a go-around should be performed, for example.

Further, in the speed information providing system 1 of this embodiment, by causing the primary flight display which is the main instrument of the cockpit instrument 5 to display the information on the predicted airspeed and the target airspeed and causing it to display the predicted speed symbol group 13 indicating the predicted airspeed and the target speed symbol 15 indicating the target airspeed while adjusting them to the speed axis of the airspeed indicator 11, the pilot can instantly know a high/low relationship between the present airspeed and the predicted airspeed to be given several seconds to several tens of seconds later and the target airspeed and can quickly select an optimal manual throttle operation.

Further, in the speed information providing system 1 of this embodiment, the information on the predicted airspeed including the variation amount is displayed as the predicted speed symbols 131, 132, and 133. Therefore, the pilot can select a manual throttle operation for optimal thrust control while considering the variation amount of the predicted airspeed.

In addition, in the speed information providing system 1 of this embodiment, the information on the predicted airspeeds including the variation amounts at the plurality of times is displayed as the predicted speed symbol group 13 at the same time. Therefore, the manual throttle operation for optimal thrust control can be selected while considering changes in predicted airspeeds including the variation amounts at the plurality of times.

In addition, in the speed information providing system 1 of this embodiment, the pilot can be given with a visual or audio warning when the predicted airspeed considering the variation amount enters the warning region. Therefore, the speed management burden on the pilot can be lightened and the safety can be improved.

In addition, in the speed information providing system 1 of this embodiment, stable automatic thrust control considering the remote turbulence is realized by calculating the thrust control data on the basis of the target airspeed on an automatic operation mode and providing it to the automatic thrust control device 6.

In addition, the present technology is not limited only to the above-mentioned embodiment and various modifications can be made without departing from the gist of the present invention as a matter of course.

### REFERENCE SIGNS LIST

1 speed information providing system
2 remote turbulence measurement device
3 flight state parameter providing unit
4 computation processing device
5 cockpit instrument
6 automatic thrust control device
11 airspeed indicator
13 predicted speed symbol group
15 target speed symbol
31 airspeed measurement unit
32 accelerometer
33 wind speed calculation unit
33 ground speed calculation unit
33 wind speed measurement unit
34 ground speed calculation unit
35 configuration providing unit
131, 132, 133 predicted speed symbol

1. An aircraft speed information providing system, comprising:
an airspeed measurement device that measures a present airspeed of an aircraft;
an acceleration measurement device that measures present acceleration of the aircraft;
a remote turbulence measurement device that is installed in the aircraft and measures remote turbulence in front of the aircraft; and
a computation processing device that calculates, a predicted airspeed of the aircraft on a basis of the measured present airspeed and present acceleration and the remote turbulence measured by the remote turbulence measurement device.

2. The aircraft speed information providing system according to claim 1, wherein
the computation processing device is configured to further calculate a variation amount of the predicted airspeed.

3. The aircraft speed information providing system according to claim 2, wherein
the computation processing device is configured to calculate the predicted airspeed and the variation amount at each of a plurality of times.

4. The aircraft speed information providing system according to claim 2, wherein
the computation processing device is configured to cause a cockpit instrument to display the calculated predicted airspeed and variation amount.

5. The aircraft speed information providing system according to claim 2, wherein
the computation processing device is configured to generate a warning notification when the predicted airspeed considering the calculated variation amount is within a warning region.

6. The aircraft speed information providing system according to claim 2, wherein
the computation processing device is configured to calculate a target airspeed on a basis of a difference between the calculated predicted airspeed and present airspeed, the calculated variation amount, and a reference speed.

7. The aircraft speed information providing system according to claim 6, wherein
the computation processing device is configured to calculate the target airspeed while considering a configuration of the aircraft.

8. The aircraft speed information providing system according to claim 6, wherein
the computation processing device is configured to cause the cockpit instrument to display the calculated target airspeed.

9. The aircraft speed information providing system according to claim 6, wherein
the computation processing device is configured to calculate control data for automatic thrust control on a basis of the calculated target airspeed.

10. An aircraft speed information providing method, comprising:
by a computation processing device installed in an aircraft,
inputting data on remote turbulence in front of an aircraft measured by a remote turbulence measurement device installed in the aircraft, and
calculating a predicted airspeed of the aircraft on a basis of the data on the remote turbulence and respective data on a present airspeed and acceleration of the aircraft.

11. A program that causes a computer to operate as
a computation processing device that
inputs data on remote turbulence in front of an aircraft. measured by a remote turbulence measurement device installed in the aircraft, and
calculates a predicted airspeed of the aircraft on a basis of the data on the remote turbulence and respective data on a present airspeed and acceleration of the aircraft.
